(19) United States
(12) Patent Application Publication
(10) Pub. No.: US 2013/0286629 A1
(43) Pub. Date: Oct. 31, 2013

(54) OPTICAL SYSTEM FOR LASER FORMING NETTED DOTS

(71) Applicant: PO-CHOU CHEN, Tu-Cheng (TW)

(72) Inventor: PO-CHOU CHEN, Tu-Cheng (TW)

(73) Assignee: HON HAI PRECISION INDUSTRY CO., LTD., Tu-Cheng (TW)

(21) Appl. No.: 13/492,928

(22) Filed: Jun. 11, 2012

(30) Foreign Application Priority Data
Apr. 27, 2012 (TW) 101115021

(51) Int. Cl. F21V 13/08; F21V 17/02

(52) U.S. Cl. 362/19

(57) ABSTRACT

An optical system for laser forming netted dots on a workpiece is provided. The optical system includes a laser light source for emitting a laser light beam having a polarized direction, a polarizing beamsplitter, a first reflecting unit and a second reflecting unit. The polarizing beamsplitter has a splitting axis deviating the polarized direction of the laser light beam 45 degree and is configured for dividing the laser light beam into a transmitting light beam and a reflected light beam with a same energy. The first reflecting unit is configured for reflecting the reflected light beam to a first predetermined position of a workpiece. The second reflecting unit is configured for reflecting the transmitting light beam to a second predetermined position of the workpiece.

### BACKGROUND

1. Technical Field

The present disclosure relates to optical systems, and particularly to an optical system for laser forming netted dots.

2. Description of Related Art

Laser light is used for forming netted dots on mold blanks for molding light guide plates. However, as the number of the netted dots is great, the time consumed in forming the netted dots is very long.

A rotatable reflecting mirror might be used for reflecting the laser light to different positions on a workpiece to accelerate the forming of the netted dots, however, as the number of the netted dots increases, the time consumed is still too long.

What is needed, therefore, is an optical system for laser forming netted dots, which can overcome the above shortcomings.

### BRIEF DESCRIPTION OF THE DRAWINGS

Many aspects of the disclosed optical system for laser forming netted dots can be better understood with reference to the following drawings. The components in the drawings are not necessarily drawn to scale, the emphasis instead being placed upon clearly illustrating the principles of the present optical system. Moreover, in the drawings, like reference numerals designate corresponding parts throughout the several views.

FIG. 1 is a schematic view of an optical system for laser forming netted dots on a light guide plate in accordance with an embodiment.

FIG. 2 shows a light path of a laser light source and a polarizing beamsplitter used in FIG. 1.

### DETAILED DESCRIPTION

Embodiments of the present optical system for laser forming netted dots on a workpiece will be described with reference to the drawings.

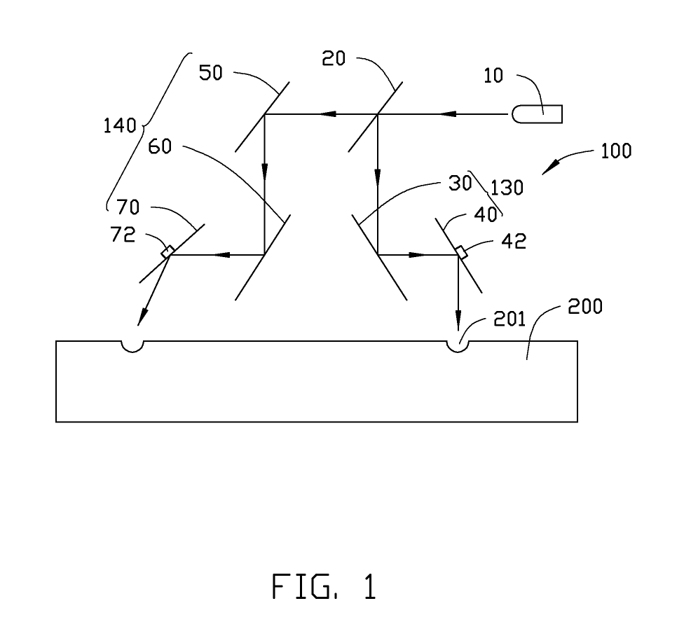

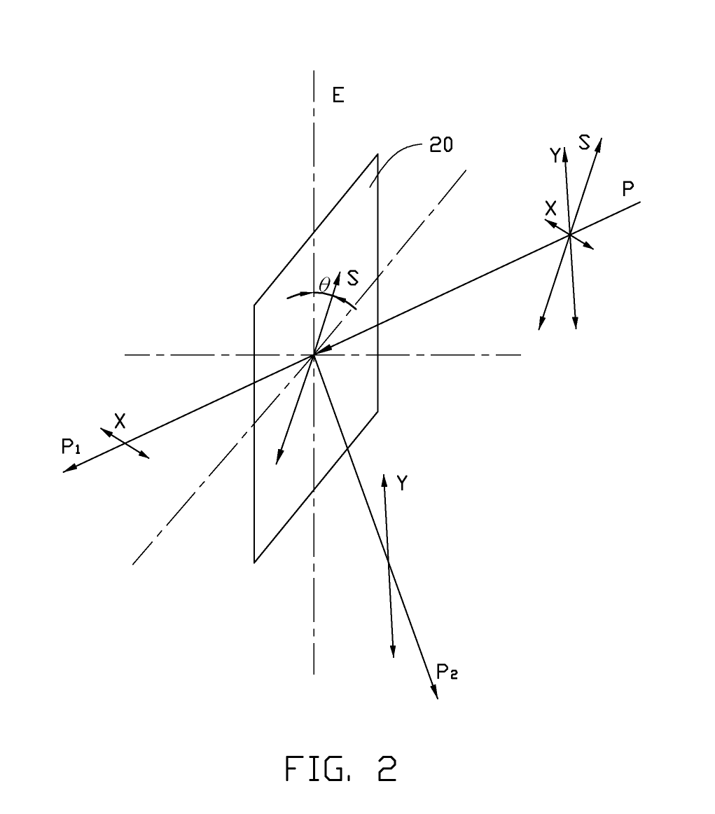

Referring to FIGS. 1 and 2, an optical system 100 in accordance with an embodiment is provided for laser forming netted dots on a workpiece 200. In the present embodiment, the workpiece 200 is a mold blank used in a mold for molding products. The optical system 100 includes a laser light source 10, a polarizing beamsplitter 20, a first reflecting unit 130 and a second reflecting unit 140.

The laser light source 10 emits a laser light beam P with a polarized direction S. A polarizing mirror or other polarizing device can be used in a light chamber of the laser light source 10 to produce the laser light beam P with the desired polarized direction S. The polarized direction S represents a single direction or wave motion that the energy of the laser light beam P is applied towards. The energy of the laser light beam P and a wavelength of the laser light beam P can be determined according to a desired size and depth of the netted dots.

The polarizing beamsplitter 20 faces the laser light source 10. Relative to an XY coordinate system organized around the polarizing beamsplitter 20 with X representing a horizontal plane and Y representing a vertical plane, a splitting axis E of the polarizing beamsplitter 20 rotates the plane of polarization of the laser light beam P an angle θ about 45 degrees. The X component of the laser light beam P which is outputted from the polarizing beamsplitter 20 is a transmitting light beam P₁, and the Y component of the laser light P which is outputted from the polarizing beamsplitter 20 is a reflected light beam P₂. If the energy of the laser light beam P is I, then the energy of the transmitting light beam P₁ is I× cos(θ)², and the energy of the reflected light beam P₂ is I× sin(θ)². As the angle θ is 45 degrees, the energy level of each of the transmitting light beam P₁ and the reflected light beam P₂ is 0.5 I.

The first reflecting unit 130 includes a first fixed reflecting mirror 30 and a first rotatable reflecting mirror 40, which are configured for receiving and reflecting the reflected light beam P₂ to a first predetermined position on the workpiece 200. In detail, the first fixed reflecting mirror 30 is fixed in the path of the light reflected from the polarizing beamsplitter 20, and itself reflects the reflected light beam P₂ onto the first rotatable reflecting mirror 40. The first rotatable reflecting mirror 40 is arranged in the path of the light reflected from the first fixed reflecting mirror 30, and itself reflects the light from the first fixed reflecting mirror 30 onto a first predetermined position of the workpiece 200 by means of being rotated. In particular, the first rotatable reflecting mirror 40 is positioned on a rotatable device 42 such that the first rotatable reflecting mirror 40 is precisely rotatable.

The second reflecting unit 140 includes a second fixed reflecting mirror 50, a third fixed reflecting mirror 60 and a second rotatable reflecting mirror 70, which are configured for receiving and reflecting the transmitting light beam P₁ onto a second predetermined position of the workpiece 200.

In detail, the second fixed reflecting mirror 50 is fixed in the light path going through the polarizing beamsplitter 20, and is configured for receiving and reflecting the transmitting light beam P₁ to the third fixed reflecting mirror 60. The third fixed reflecting mirror 60 is fixed in the light path from the second fixed reflecting mirror 50, and is configured for receiving and reflecting the light from the second fixed reflecting mirror 50 onto the second rotatable reflecting mirror 70. The second rotatable reflecting mirror 70 is arranged in the path of the light reflected from the third fixed reflecting mirror 60, and is configured for receiving and reflecting the light from the third fixed reflecting mirror 60 onto a second predetermined position of the workpiece 200 by means of being rotated. In particular, the second rotatable reflecting mirror 70 is positioned on a rotatable device 72.

The first fixed reflecting mirror 30 and the third fixed reflecting mirror 60 are arranged back to back obliquely. The first rotatable reflecting mirror 40 and the second rotatable reflecting mirror 70 have a similar relationship but are further apart. The first rotatable reflecting mirror 40 and the second rotatable reflecting mirror 70 are spaced the same distance from the workpiece 200, such that the transmitting light beam P₁ and the reflected light beam P₂ can form the same netted dots 201 with the same size and the same depth and the same energy. In the present embodiment, the netted dots 201 are concave in the workpiece 200.

In an alternative embodiment, the second fixed reflecting mirror 50 and third fixed reflecting mirror 60 can be replaced by a first movable reflecting mirror and a second movable reflecting mirror, and accordingly the second rotatable reflecting mirror 70 is movable jointly with one of the first and second movable reflecting mirrors, such that a distance between the second reflecting unit 140 as a unit and the polarizing beamsplitter 20 can be adjusted, and therefore different positions of the workpiece 200 become accessible and can be machined.

In other embodiments, the second reflecting unit 140 can only includes a rotatable reflecting mirror arranged in the light path going through the polarizing beamsplitter 20 to reflect the transmitting light P₁ onto a second predetermined position of the workpiece 200. That is, the first and second fixed reflecting mirrors are not essential.

Furthermore, multiple polarizing beamsplitters can be used in the optical system to divide multiple laser light beams into transmitting light beam P1 and reflected light beam P2, then multiple laser light beams can machine the workpiece 200 at a same time, and the machining time can be further shortened.

The above-described optical system uses the polarizing beamsplitter to divide the incident laser light beam into two laser light beams with the same energy, and the cooperation of the fixed and/or movable reflecting mirror and the rotatable reflecting mirror guides the laser light beams onto two or more positions on the workpiece. In this way, a time saving of at least 50 percent can be made for forming the netted dots.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An optical system for laser forming netted dots on a workpiece, the optical system comprising:
a laser light source for emitting a laser light beam having a polarized direction;
a polarizing beamsplitter having a splitting axis deviating the polarized direction of the laser light beam 45 degrees, the polarizing beamsplitter configured for dividing the laser light beam into a transmitting light beam and a reflected light beam with a same energy;
a first reflecting unit configured for reflecting the reflected light beam to a first predetermined position of a workpiece; and
a second reflecting unit configured for reflecting the transmitting light beam to a second predetermined position of the workpiece.

2. The optical system of claim 1, wherein the first reflecting unit comprises a first fixed reflecting mirror and a first rotatable mirror, the first fixed reflecting mirror configured for reflecting the reflected light beam to the first rotatable mirror, the first rotatable mirror configured for reflecting the reflected light beam to the first predetermined position by rotation thereof.

3. The optical system of claim 2, wherein the second reflecting unit comprises a second fixed reflecting mirror, a third fixed reflecting mirror and a second rotatable mirror, the second fixed reflecting mirror configured for reflecting the transmitting light beam to the third fixed reflecting mirror, the third fixed reflecting mirror configured for reflecting the transmitting light beam to the second rotatable reflecting mirror, and the second rotatable reflecting mirror configured for reflecting the transmitting light beam to the second predetermined position by rotation thereof.

4. The optical system of claim 3, wherein the first fixed reflecting mirror and the third fixed reflecting mirror are arranged back to back obliquely.

5. The optical system of claim 3, wherein the first rotatable reflecting mirror and the second rotatable reflecting mirror are arranged back to back obliquely.

6. The optical system of claim 5, wherein the first rotatable reflecting mirror and the second rotatable reflecting mirror are spaced a same distance from the workpiece.

7. The optical system of claim 3, wherein each of the first rotatable reflecting mirror and the second rotatable reflecting mirror is rotatable by a rotatable device.

8. The optical system of claim 2, wherein the second reflecting unit comprises a first movable reflecting mirror, a second movable reflecting mirror and a second rotatable mirror, the first movable reflecting mirror configured for reflecting the transmitting light beam to the second movable reflecting mirror, the second movable reflecting mirror configured for reflecting the transmitting light beam to the second rotatable reflecting mirror, and the second rotatable reflecting mirror being movable jointly with one of the first and second movable reflecting mirrors and configured for reflecting the transmitting light beam to the second predetermined position by rotation thereof.

9. The optical system of claim 8, wherein the first rotatable reflecting mirror and the second rotatable reflecting mirror are arranged back to back obliquely.

10. The optical system of claim 9, wherein the first rotatable reflecting mirror and the second rotatable reflecting mirror are spaced a same distance from the workpiece.

11. The optical system of claim 2, wherein the second reflecting unit is a second rotatable reflecting mirror, and the second rotatable reflecting mirror is configured for reflecting the transmitting light beam to the second predetermined position by rotation thereof.
